(19) United States
(12) Patent Application Publication
(10) Pub. No.: US 2005/0283753 A1
(43) Pub. Date: Dec. 22, 2005

(54) Alert triggers and event management in a relationship system

(76) Inventors: Denise Ho, Mountain View, CA (US); Bryan Hughes, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/914,858

(22) Filed: Aug. 9, 2004

Related U.S. Application Data
(60) Provisional application No. 60/494,230, filed on Aug. 7, 2003.

(51) Int. Cl. G06F 9/44; G06F 15/173; G06F 17/30

(52) U.S. Cl. 717/102; 707/3; 709/224

(57) ABSTRACT

A method and apparatus to manage alert triggers in a relationship system are disclosed. In one embodiment, the method includes maintaining a set of alert triggers that define operations for detecting changes pertaining to elements of a relationship graph. The elements of the relationship graph include nodes representing entities and edges representing relationships between entities. The method further includes performing the operations defined by the set of alert triggers, and providing an alert to one or more users when any of the defined operations satisfy an alert condition associated with a corresponding alert trigger.

### RELATED APPLICATIONS

This application is related to and claims the benefit of U.S. Provisional Application No. 60/494,230 filed on Aug. 7, 2003, which is hereby incorporated by reference.

### FIELD OF THE INVENTION

This invention relates generally to relationships systems, and more particularly to managing events in a relationship system.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2004, Spoke Software, Inc., All Rights Reserved.

### BACKGROUND OF THE INVENTION

Currently various computer-based applications manage and track interactions between people in conjunction with, for example, a sales process. Customer Relationship Management (CRM) systems that incorporate sales force automation methodologies typically focus on pipeline management and on monitoring the sales process between known endpoints but the current CRM systems cannot identify a new endpoint or provide a guided process to a new endpoint.

Social Network Theory has evolved to characterize the behavior of “referral networks.” Researchers have described mathematically the multiple levels of relationships existing among networks of people, for example, the situation where two friends, Jim and Fred, may see each other every day at the gym (high personal relationship strength) but never discuss business (low professional relationship strength). Further, social network theorists have shown that networks exhibit predictable behaviors at the macro and micro levels. As the networks grow, they tend to preferentially attach to the more connected nodes, with the “rich getting richer”.

Bridges between networks (particularly between highly connected nodes) that span enterprises are important for sales prospecting purposes. Studies of connections among these networks demonstrated what might appear to be counter-intuitive: when it comes to finding a job, our “weak social links” are more important than the more cherished, strong, relationships, indicating that groups of tightly coupled friendship circles connect to other groups of tightly coupled friendships via “bridges” that sharply broaden the job search space.

Although Social Network Theory has established that evaluating a person's social network can generate high quality contacts, analysis of social relationship information to identify and quantify referral routes to a desired person or company has not been incorporated into computer-based applications. In particular, the identification of “invisible” referral routes has not been addressed, e.g., Fred went to school with the Vice President of Purchasing at a particular company Jim has as a sales target.

### SUMMARY OF THE INVENTION

A method and apparatus to manage alert triggers in a relationship system are disclosed. According to one aspect of the invention, the method includes maintaining a set of alert triggers that define operations for detecting changes pertaining to elements of a relationship graph. The elements of the relationship graph include nodes representing entities and edges representing relationships between entities. The method further includes performing the operations defined by the set of alert triggers, and providing an alert to one or more users when any of the defined operations satisfy an alert condition associated with a corresponding alert trigger.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

FIG. 1A is a diagram illustrating an operational overview of an embodiment of the invention;

FIG. 1B is a diagram illustrating a privacy feature of the embodiment of FIG. 1A;

FIG. 2 is a diagram illustrating an overview of data flow and processing modules of an embodiment of the invention;

FIG. 3 is a block diagram illustrating a system architecture for an embodiment of the invention;

FIGS. 4-7 are flow diagrams of methods to be performed by a server according to an embodiment of the invention;

FIG. 8A is a diagram of one embodiment of an operating environment suitable for practicing the present invention; and

FIG. 8B is a diagram of one embodiment of a computer system suitable for use in the operating environment of FIG. 8A.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

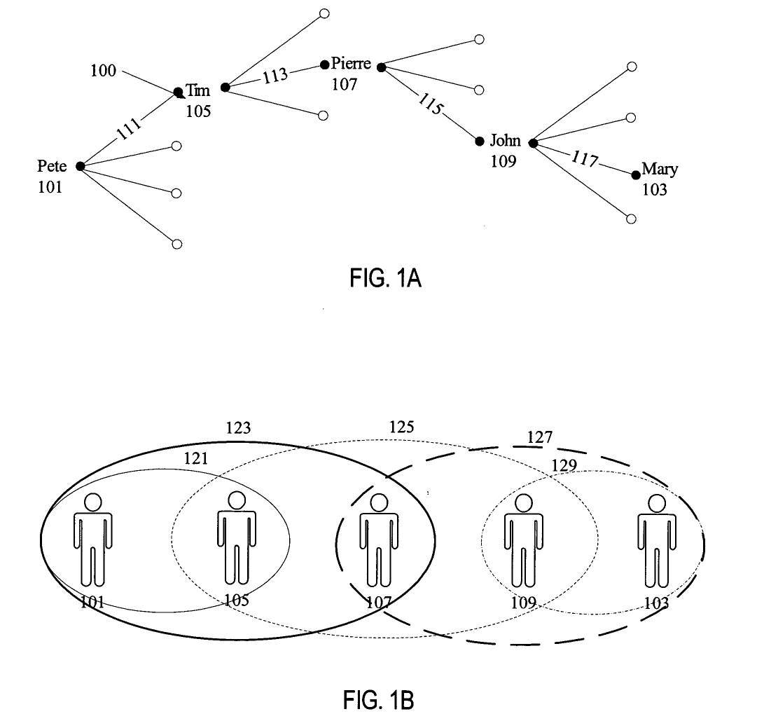

An overview of the operation of an embodiment of an entity relationship analysis and mapping system is described with reference to FIG. 1A. The system utilizes social network models to build graphs that represent relationships among entities. For sake of simplicity in description, an entity is generally assumed herein to be an individual, but an entity may also be an organization of people, e.g., a company, or collection of characteristics shared by people, e.g., culture or country. Furthermore, the operations described herein may be requested or invoked by other system services, such as applications and computerized agents, as well as entities.

As illustrated in FIG. 1A, relationships among five people form a relationship graph 100 containing nodes 101, 103, 105, 107, 109, representing the people, that are connected by edges 111, 113, 115, 117, representing the relationships among the people. The relationship graph 100 is built from contact data extracted from electronic communication data sources and updated when the source data changes or as a result of processing of the data in the graph. The data source may be an electronic document, such as an address book or an attachment to a message, and/or electronic communication metadata, such as email address headers, instant message logs, phone logs, or the like. It will be appreciated that when the entities represent organization or characteristic collections, additional electronic data sources, such as organization charts, may be used to create the nodes.

Each edge directly connecting a pair of nodes is assigned a “Strength of Relationship” (SOR) weight based on the quality and frequency of contact between the two people (not illustrated). The relationship graph 100, along with the SOR between pairs of nodes, establishes a “Network Strength of Relationship” (NSOR) between every reachable pair of nodes in the social network represented by the graph 100, and an “Aggregate Strength of Relationship” (ASOR) between either subscribers to the system, or groups of subscribers, and targets who are subscribers or non-subscribers known to subscribers (“leaves”), or groups of subscribers and/or leaves.

As illustrated, even though Pete and Mary are not directly connected, Pete can “reach” Mary by being referred through the social network represented by the graph 100. Starting with Pete's immediate relationships, the system of the present invention analyzes the relationship graph 100 to dynamically establish a path of intermediate nodes 105, 107, 109 that ends with the node 103, and suggests Tim as Pete's starting contact for his referral request. Pete invokes a workflow function within the system to begin the process of forwarding his referral request to Mary. The system will send a message to Tim, informing him that Pete is requesting a referral to Mary and that Pierre is the next contact in the referral path. If Tim decides to forward the referral request to Pierre, Pierre will receive a similar message indicating that John is the next contact. In an alternate embodiment, any person receiving the referral request may determine that a person different than that originally selected by the system should be the next link in the path. Furthermore, although only one path is illustrated in FIG. 1A, it will be appreciated that the system may rank multiple paths based on various relationship criteria, including SOR value. In one embodiment, the relationship criteria include common affiliations, such as alma maters, shared between people. It also will be appreciated that additional weights may be calculated for each edge and factored into the path calculation; some exemplary weights are described further below.

Any person in the path may decline to forward the request to the next person, but a privacy protection scheme for the workflow masks the break in the referral chain so that the request originator only knows that the referral request was not successful, not where the chain was broken. The privacy protection scheme is illustrated in FIG. 1B as a series of visibility windows, 121, 123, 125, 127, 129, that block the identities of people in the path outside the immediate scope of the current node who are neither the request originator nor destination. Thus, the visibility window 121 covers Pete 101 and Tim 105, but not Tim's contact Pierre 107. The visibility window 123 allows Tim 105 to see both Pete 101 and Pierre 107, but not Pierre's contact John 109. Similarly, Pierre 107 sees Tim 105 and John 109 through visibility window 125, and John 109 sees Pierre 107 and Mary 103 through visibility window 127. As illustrated, Mary 103 only sees John 109 through visibility window 129. Although not illustrated in FIG. 1B, each visibility window includes the identity of Pete 101 as the originator of the referral and Mary 103 as the destination. In an alternate embodiment, each contact in the chain can elect to hide the identity of the originator of the request. The system may also include a referral proxy function that allows a subscriber to have his/her identity masked when they are the next contact in a path and the previous contact was a particular individual. For example, in a professional services firm, all partners are required to help each other but inter-personal dynamics lead to a situation where one partner may prefer to help another under only certain circumstances.

Assuming someone in the path does decline to forward the request, the system may use that information to recalculate the SOR between the sender of the request and the person that broke the chain. Conversely, if node N passes on the referral it receives from node N−1, the SOR between nodes N−1 and N increases.

In one embodiment, the system maintains three categories of data about people: public data, private data, and “inferred” data. Public data is information that is generally available, such as on the Internet, or is specifically made available to all subscribers to the system. For example, name, title, and employer fall in the public data category. When a change in public data is extracted from a sufficient number of data sources, the public data is updated if the change is considered “correct” as described further below. Private data is information that every subscriber individually maintains for the other people with which he/she has direct relationships. Thus, A's private data may reflect a change in the mobile telephone number for B while C continues to see only the old number. Inferred data is information developed by the system based on interactions among the subscribers. Thus, in the above example, the system may infer that B has changed jobs based on A's private data. In one embodiment, inferred data is protected with additional security, such as encryption, to safeguard the personal actions of the subscribers.

As previously described, the relationship graph 100 illustrated in FIG. 1A is established based on direct communications among people. However, a new subscriber may not have supplied sufficient information to the system to enable the system to establish a referral path. In an embodiment not illustrated, subscribers may be members of public or private groups, and the system searches through the contacts of the group when establishing a path for a group member. Public groups are open to anyone; joining a private group requires permission from a group manager, typically the creator of the group.

Furthermore, in one embodiment, the system distinguishes among subscribers to the system and those non-subscribers with whom the subscribers communicate to protect the privacy of the non-subscribers. For example, assume non-subscriber A sends email to subscriber B and carbon copies fifteen other people. A has thus exposed the fifteen other people to B and the system adds the fifteen people to B's relationship graph as “shadow” nodes, which it includes in its search when B requests a referral path. Additionally, A is added as a “shadow” subscriber. However, because A is a shadow subscriber, no subscribers other than B can search through A and any workflow that identifies B as an intermediary link to one of the fifteen ends at B (unless A is also a shadow subscriber for any other subscriber in addition to B).

While the system has been described in terms of relationships between pairs of nodes, it will be appreciated that nodes may be grouped into sets and that relationships may be established among nodes and sets of nodes in various combinations and processed in a similar fashion to relationships among individual nodes.

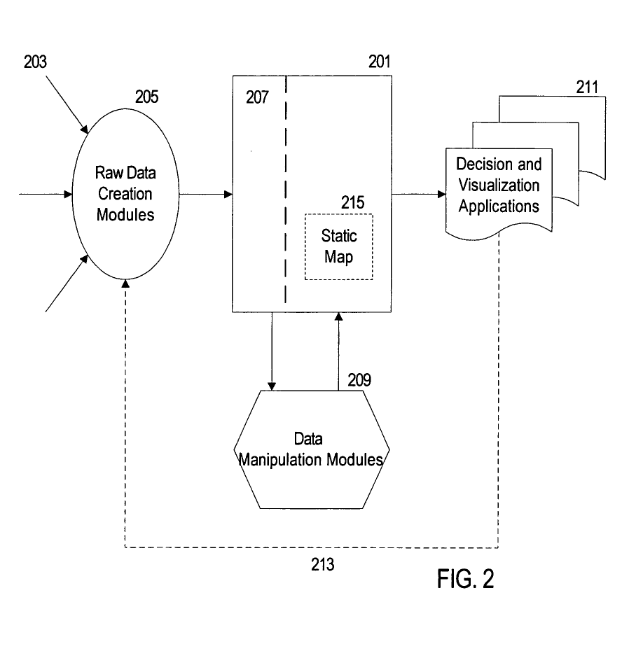

FIG. 2 illustrates one embodiment of logical data flows and modules that build, maintain, and use a global relationship graph, such as graph 100 in FIG. 1A. Raw data is extracted from data sources 203 by modules 205. The raw data is stored in a local area 207 in a relationship graph data store 201 for subsequent manipulation by modules 209 into a global relationship graph. It will be appreciated that data sources 203 may be any resource that contains relationship information for people or entities that affect the global relationship graph. Instances, referred to herein as “maps,” of the global relationship graph may be created to represent all or portions of the global relationship graph and may present the relationship data in different formats. As illustrated in FIG. 2, static map 215 is built from the global relationship graph and used by decision and visualization applications 211, such as, for example, to establish a referral path. Results from the applications 211 may be fed back, as illustrated by arrow 213, into the relationship graph data store 201 to update the global relationship graph. Thus, the global relationship graph is dynamic and reflects information “learned” from the operations of applications 211.

As will be discussed in more detail below, the applications 211 may further use the dynamic nature of the global relationship graph to discover recent changes concerning elements of the relationship graph and alerting subscribers to these changes. In particular, the applications 211 may maintain a set of alert triggers that define operations for detecting changes pertaining to the elements of the relationship graph, perform the operations defined by the set of alert triggers, and provide alerts to users when the defined operations satisfy alert conditions associated with the corresponding alert triggers.

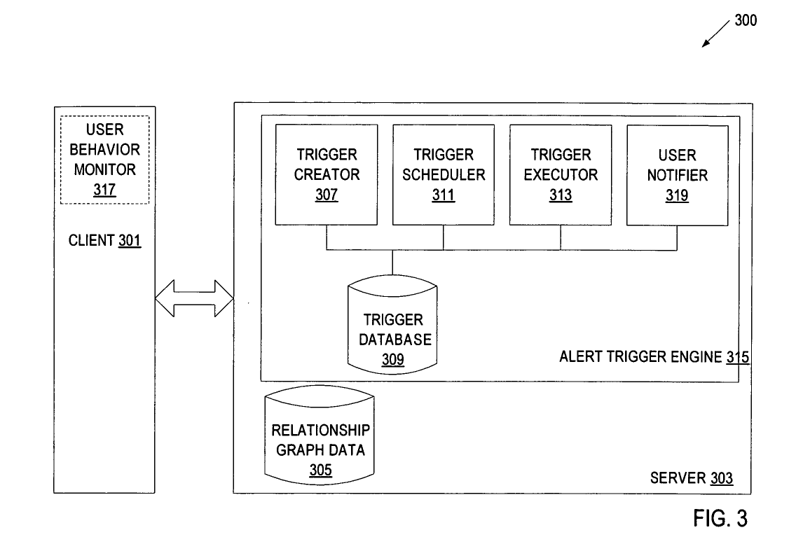

FIG. 3 is a block diagram of one embodiment of a system 300 for managing alert triggers in a relationship system. Each alert trigger defines one or more operations for detecting changes pertaining to elements of a relationship graph. As discussed above, the elements of a relationship graph include entities (e.g., individuals, organizations of people, collections of characteristics shared by people, etc.) and relationships between the entities. In addition, an alert trigger may be associated with an alert condition that is compared with the result of the corresponding operation(s) to determine whether interested users should be alerted to this result. An alert trigger may be used to alert a user to a change in the result of a specific search (e.g., a search for a contact in a specific company), a change in the content and/or context concerning an entity of the relationship graph (e.g., an addition of details about an entity), a change in a user's relationship score with an entity, a detection of a new personal relationship of a user, etc.

The system 300 includes a client 301 (or clients) for each individual subscriber to the system 300 and a server 303 that manages the global relationship graph. The client 301 includes a user behavior monitor 317 that will be discussed in more detail below. The server 303 includes a relationship graph data store 305 and alert trigger engine 315 that may be part of decision and visualization applications 211 of FIG. 2. The relationship graph data store 305 may store data of a single relationship graph or multiple relationship graphs. The alert trigger engine 315 is responsible for managing alert triggers reflecting changes that pertain to entities of the relationship graph(s) stored in the relationship graph data store 305.

In one embodiment, the alert trigger engine 315 includes a trigger creator 307, a trigger database 309, a trigger scheduler 311, a trigger executor 313, and a user notifier 319. The trigger creator 307 is responsible creating new alert triggers and storing them in the trigger database 309. Each alert trigger is associated with one or more operations for detecting a specific change in the relationship graph, an alert condition to be compared with the result of the operations, and one or more recipients of an alert that may result from the execution of the alert trigger. In one embodiment, an alert trigger is also associated with a frequency parameter specifying how often the operations defined by the alert trigger should be performed. In one embodiment, the alert trigger parameters are specified by a user. A user may be a subscriber of the system 300 or an administrator of the system 300. In another embodiment, the alert trigger parameters may be determined by the trigger creator 307. For example, the trigger creator 307 may identify an operation and an alert condition by receiving an indication of a user interest in the result of this operation. For example, the trigger creator 307 may detect that a user's search for a contact in a specific company did not produce any result, and offer the user to activate a trigger that would send an alert to the user when the search result changes. If the user asks for the activation, the trigger creator 307 then creates a new alert trigger and defines a search previously submitted by the user as a trigger's operation and the search result set of 1 or greater as the trigger's alert condition.

The trigger scheduler 311 is responsible for scheduling the execution of alert triggers stored in the trigger database 308. In one embodiment, the trigger scheduler 311 schedules the execution of the alert triggers based on their frequency parameters. Alternatively, the trigger scheduler 311 may schedule the execution of alert triggers at predefined time intervals, or based on a prioritization scheme or any other scheduling mechanism.

The trigger executor 313 is responsible for executing the alert triggers according to the schedule supplied by the trigger scheduler 311. In particular, the trigger executor 313 executes each alert trigger by performing one or more operations defined by a relevant alert trigger, and evaluating the result of the operations to determine whether it satisfies an alert condition associated with the relevant alert trigger. In one embodiment, the operations defined by the alert trigger are performed by the trigger executor 313 (e.g., by submitting a search for an entity or comparing current notes concerning an entity with previously saved notes concerning the entity). In another embodiment, the operations defined by the alert trigger are performed by the trigger executor 313 in cooperation with a user behavior monitor 317 residing on a corresponding client 301. In particular, the user behavior monitor 317 may collect information identifying new relationships of the user and send the collected information to the server 303 where the trigger executor 313 may periodically evaluate this information to determine whether it satisfies an alert condition of a relevant alert trigger (e.g., a new personal relationship alert trigger). The set of monitoring operations may include, for example, searching local files for new accounts created by the user, scanning email messages of the user to find new email recipients and senders, etc.

The notifier 319 is responsible for providing an alert to one or more users when the operations satisfy a relevant alert condition. In one embodiment, the notifier 319 communicates to the users information identifying the corresponding alert trigger and a result of said any of the plurality of operations (e.g., via an email, a voice message or any other communication media).

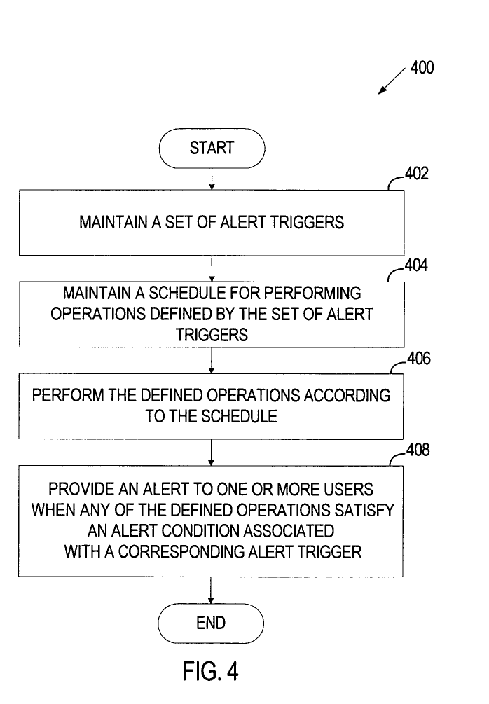

FIG. 4 is a flow diagram of one embodiment of a method 400 for managing alert triggers in a relationship system. Method 400 may be performed by processing logic, which resides on a server (e.g., server 303 of FIG. 3) and may comprise hardware, software, or a combination of both.

Referring to FIG. 4, method 400 begins with processing logic maintaining a set of alert triggers (block 402). As discussed above, each alert trigger is associated with one or more operations for detecting a specific change in the relationship graph, an alert condition to be compared with the result of the operations, and one or more recipients of an alert produced by the alert trigger. In one embodiment, an alert trigger is also associated with a frequency parameter specifying how often the operation defined by the alert trigger should be performed. In response to a user request, an alert trigger may be added to the set or deleted from the set. An operation defined by the alert trigger may be specified by a user or determined by processing logic. For example, processing logic may identify an operation by receiving an indication of a user interest in the result of this operation, or by receiving an indication of a user interest in certain information and determining which operation should be performed to obtain this information.

At processing block 404, processing logic maintains a schedule for performing operations defined by the set of alert triggers. The schedule may be compiled based on frequency parameters associated with the alert triggers. Alternatively, the schedule may be compiled based on a prioritization scheme or any other scheduling mechanism. Processing logic updates the schedule when alert triggers are added to, or removed from, the set of current alert triggers.

At processing block 406, processing logic performs the defined operations according to the schedule, and compares the results of the operations with corresponding alert conditions.

When processing logic detects that an alert condition is satisfied, processing logic provides an alert to a user or a group of users associated with the relevant alert trigger (processing block 408). In one embodiment, processing logic provides an alert by sending an email identifying the relevant alert trigger and the satisfied alert condition. Alternatively, processing logic provides an alert to the user via a voice message or any other communication media

In one embodiment, an alert trigger may be a member alert trigger or a global alert trigger. A member alert trigger is an alert trigger created for a specific subscriber. A global alert trigger is an alert trigger created for a group of subscribers. Examples of member alert triggers may include a weakening/strengthening relationship trigger that causes an alert to be sent when the user's relationship score with a specific entity (or the user's aggregated relationship score with sets of entities that may indicate the growing strength at a target company) begins to weaken/strengthen, a newly discovered relationship trigger that causes an alert to be sent when the path to a specific entity is changed, a new personal relationship trigger that causes an alert to be sent when a new personal relationship of the user is detected, a new search result trigger that causes an alert to be sent when the result of a specific search changes, a new content trigger that causes an alert to be sent when information about an entity changes, etc. Examples of global alert triggers may include a weakening/strengthening relationship alert trigger that causes an alert to be sent to a group of users (e.g., account team members) when their relationship score with a target entity or a target company begins to weaken/strengthen, a newly discovered relationship alert trigger that causes an alert to be sent to a group of users when the reachable space at the target company changes, etc.

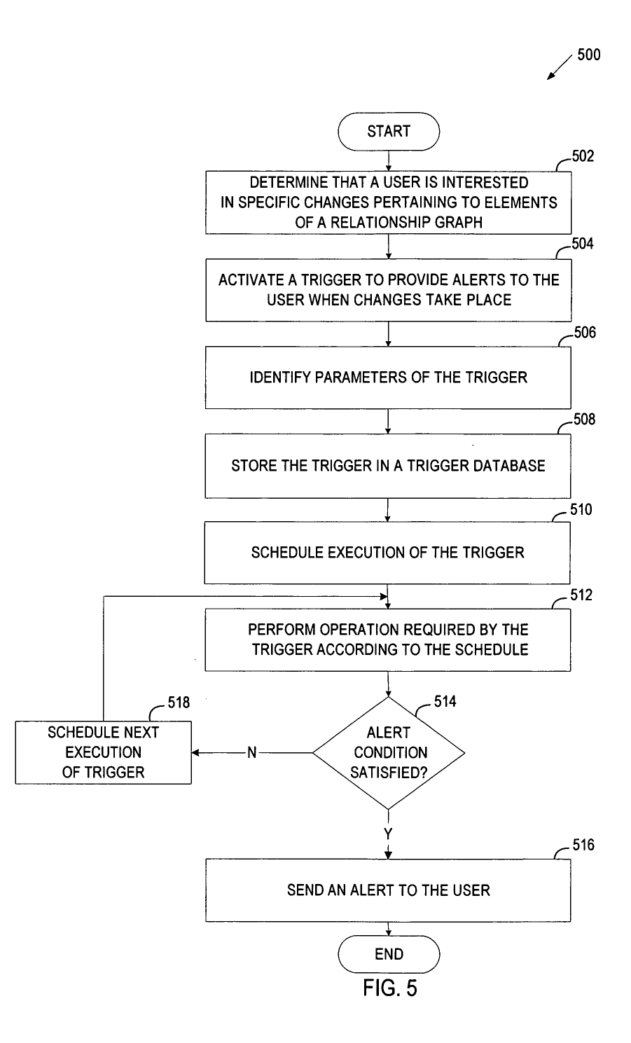

FIG. 5 is a flow diagram of one embodiment of a method 500 for processing a member alert trigger. Method 500 may be performed by processing logic, which resides on a server (e.g., server 303 of FIG. 3) and may comprise hardware, software, or a combination of both.

Referring to FIG. 5, method 500 begins with processing logic determining that a user is interested in learning about specific changes pertaining to elements of a relationship graph (processing block 502). In one embodiment, processing logic makes this determination based on user preferences. In another embodiment, processing logic makes this determination upon receiving a user request to activate an alert trigger associated with an operation for detecting such a change (e.g., a weakening relationship alert trigger, a strengthening relationship alert trigger, a newly discovered relationship alert trigger, a new personal relationship alert trigger, a new search result alert trigger, a new content alert trigger, etc.). In yet another embodiment, processing logic makes this determination upon receiving a user request for an operation that detects such a change. For example, processing logic may receive a user request to search for a contact in a specific company, a user request to view notes concerning a specific entity, etc.

At processing block 504, processing logic creates an alert trigger to provide alerts to the user when changes, which are of interest to the user, take place. In one embodiment, processing logic creates an alert trigger in response to an explicit request of the user to activate this trigger. In another embodiment, processing logic creates an alert trigger in response to an implicit request of the user to activate the trigger (e.g., by selecting certain user preferences in a user profile). In yet another embodiment, processing logic creates an alert upon receiving a user request for an operation that detects a specific change concerning an element of the relationship graph, offering the user to activate a trigger configured to alert the user to the specific change, and receiving the user request for the activation.

At processing block 506, processing logic identifies parameters of the alert trigger. Exemplary parameters of an alert trigger may include one or more operations to be performed by the alert trigger, the owner of the alert trigger, an alert condition, frequency of the trigger execution, and a trigger deactivation parameter. In one embodiment, processing logic identifies the parameters of the alert trigger based on the user input (e.g., the user may specify some or all of the parameters, or choose default parameters of the requested alert trigger). In another embodiment, processing logic identifies the parameters of the alert trigger by analyzing the user behavior prior to the creation of the trigger. For example, if the alert trigger was created as a result of a user request to search for a contact in a specific company, processing logic may define the requested search as a trigger's operation and a positive change in the search result set as the trigger's alert condition.

The frequency and trigger deactivation parameters of an alert trigger may be predetermined or specified by the user. The trigger deactivation parameter may specify whether an alert trigger should be deactivated following an alert.

Next, processing logic stores the new alert trigger in a trigger database (processing block 508) and schedules the execution of the trigger (processing block 510). The execution of the trigger may be scheduled based on its frequency parameter, a prioritization scheme, or any other scheduling mechanism.

Further, processing logic performs, according to the schedule, the operation defined by the alert trigger (processing block 512), and determines whether an alert condition is satisfied (processing box 514). If not, processing logic schedules the next execution of the alert trigger (processing block 518) and returns to processing block 512. If so, processing logic sends an alert to the user (e.g., via an email) (processing block 516). In one embodiment, if the trigger deactivation parameter does not require a deactivation of the trigger following an alert, processing logic proceeds to processing block 518. Alternatively, method 500 ends after the execution of processing block 516.

In one embodiment, a user can deactivate an alert trigger at any time. Upon receiving a user request for deactivation, processing logic removes the alert trigger from the schedule and the trigger database.

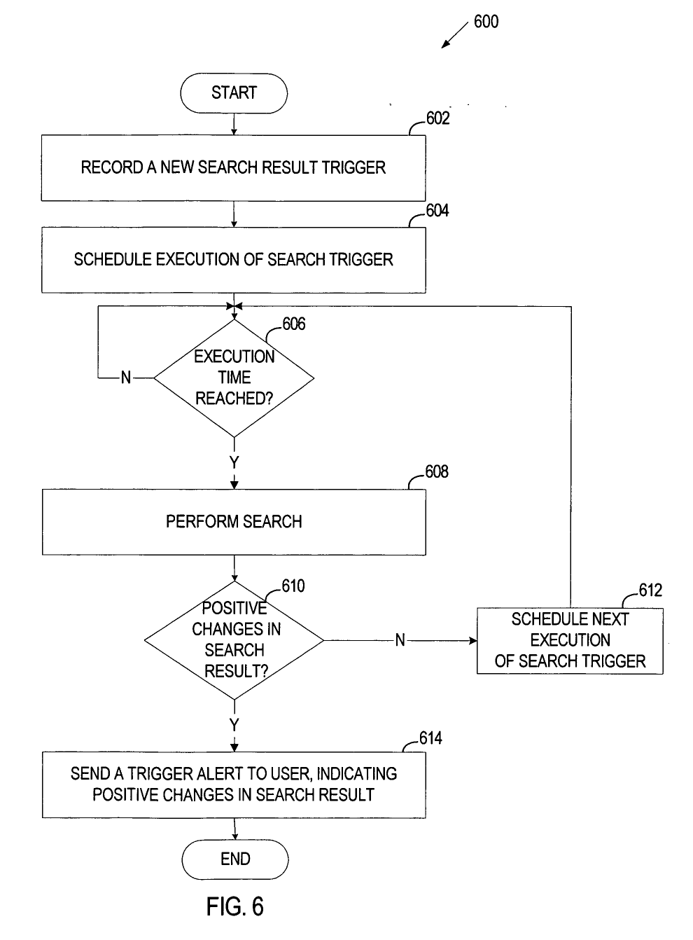

As discussed above, one example of a member alert trigger is a new search result alert trigger. FIG. 6 is a flow diagram of one embodiment of a method 600 for processing an exemplary new search result alert trigger. Method 600 may be performed by processing logic, which resides on a server (e.g., server 303 of FIG. 3) and may comprise hardware, software, or a combination of both.

Referring to FIG. 6, method 600 begins with recording a new search result trigger (processing block 602). In one embodiment, processing logic records the name of the new search result trigger, the identifier of the owner of the new search result trigger, a string of the desired search, a search result set, frequency of the search, and a trigger deactivation parameter.

At processing block 604, processing logic schedules the execution of the new search result trigger. The execution of the new search result trigger may be scheduled based on its frequency parameter, a prioritization scheme, or any other scheduling mechanism.

Further, when the scheduled time reached (processing box 606), processing logic performs the relevant search (processing block 608) and compares the current search result with the previous search result. If the current search result has no positive changes (i.e., the number of elements in the result set has not changed and the elements themselves have not changed) (processing box 610), processing logic schedules the next execution of the new search result trigger (processing block 612) and returns to processing box 606. If the current search result has positive changes (i.e., either the number of elements in the result set has changed or any of the elements have changed), processing logic sends an alert to the user (e.g., via an email), indicating positive changes in the search result (processing block 614). In one embodiment, if the trigger deactivation parameter does not require a deactivation of the new search result trigger following an alert, processing logic updates the recorded search result set with the new search result set and proceeds to processing block 612. Alternatively, method 600 ends after the execution of processing block 614.

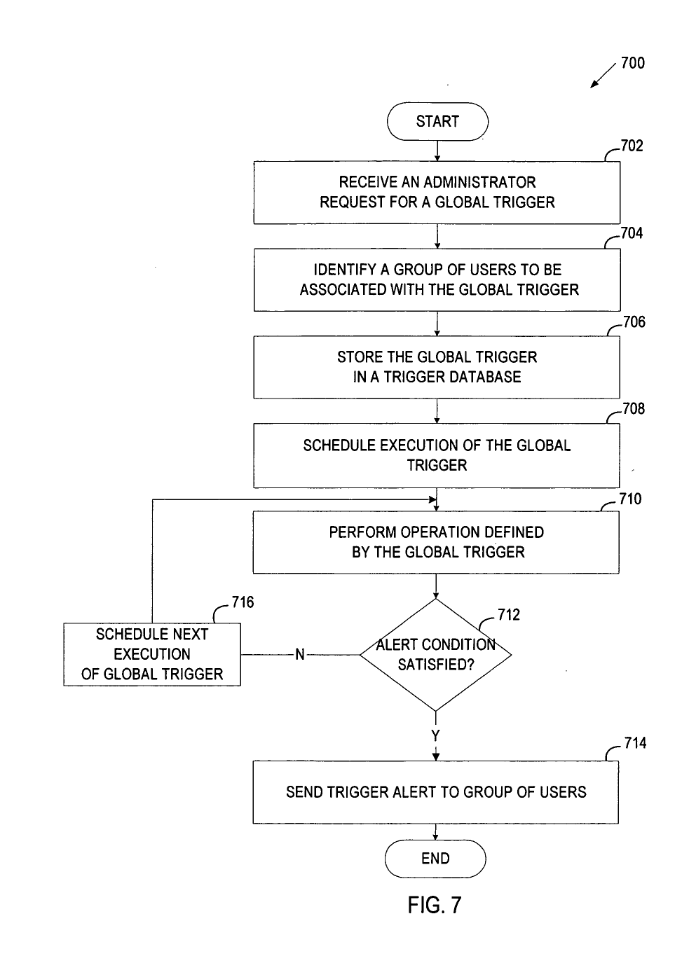

FIG. 7 is a flow diagram of one embodiment of a method 500 for processing a global alert trigger. Method 700 may be performed by processing logic, which resides on a server (e.g., server 303 of FIG. 3) and may comprise hardware, software, or a combination of both.

Referring to FIG. 7, method 700 begins with processing logic receiving an administrator's request for a global alert trigger (processing block 602). As discussed above, a global trigger is a trigger created for a group of subscribers (e.g., members of an accounts team). In one embodiment, processing logic provides a user interface facilitating a selection of a global alert trigger from a list of available alert triggers.

At processing block 704, processing logic identifies a group of users to be associated with the global alert trigger. In one embodiment, processing logic identifies the group of users for the trigger based on the input of the administrator. In another embodiment, processing logic identifies the group of users for the trigger by determining which subscribers may be interested in the result of the operation defined by the global alert trigger.

Next, processing logic stores the new global alert trigger in a trigger database (processing block 706) and schedules the execution of the global alert trigger (processing block 708). The execution of the global alert trigger may be scheduled based on its frequency parameter, a prioritization scheme, or any other scheduling mechanism.

Further, processing logic performs, according to the schedule, the operation defined by the global alert trigger (processing block 710) and determines whether an alert condition is satisfied (processing box 712). If not, processing logic schedules the next execution of the global alert trigger (processing block 716) and returns to processing block 710. If so, processing logic sends an alert to the group of users (e.g., via an email) (processing block 714). In one embodiment, if the trigger deactivation parameter does not require a deactivation of the trigger following an alert, processing logic proceeds to processing block 716. Alternatively, method 700 ends after the execution of processing block 714.

In one embodiment, any user from the group associated with the global alert trigger may indicate that they no longer want to receive alerts caused by this global alert trigger. In response to such an indication, processing logic removes the user from the group associated with the global alert trigger in the trigger database.

In practice, the methods described herein may constitute one or more programs made up of machine-executable instructions. Describing the method with reference to the flowcharts in FIGS. 4-7 enables one skilled in the art to develop such programs, including such instructions to carry out the operations (acts) represented by the logical blocks on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated herein without departing from the scope of the invention and that no particular order is implied by the arrangement of blocks shown and described herein. Moreover, one of skill in the art will immediately recognize that the various processes described with reference to FIGS. 4-7 may be performed in a batch mode as well as in an interactive mode, or in parallel as well as in serial processes.

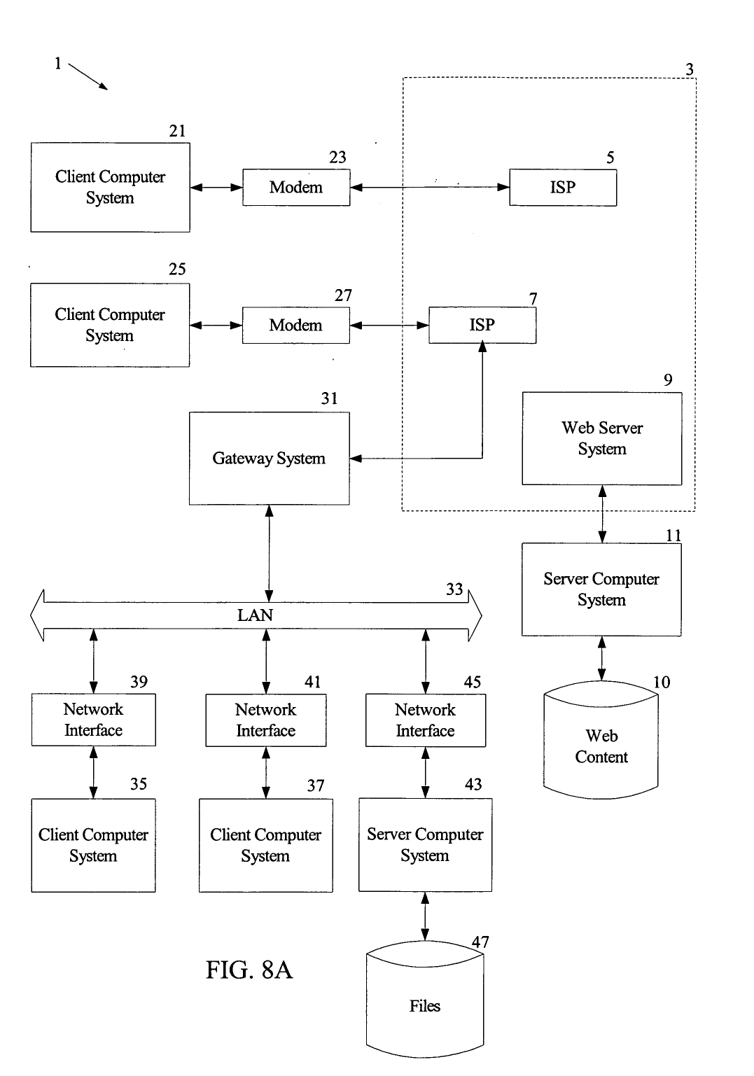

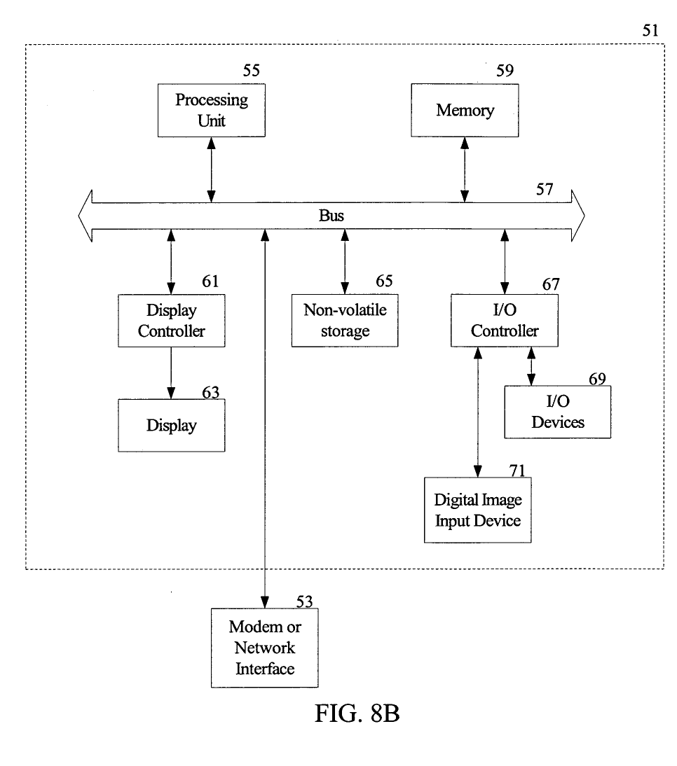

The following description of FIGS. 8A-B is intended to provide an overview of computer hardware and other operating components suitable for performing the methods of the invention described above, but is not intended to limit the applicable environments. One of skill in the art will immediately appreciate that the invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8A shows several computer systems 1 that are coupled together through a network 3, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems, such as client computer systems 21, 25, 35, and 37 obtain access to the Internet through the Internet service providers, such as ISPs 5 and 7. Access to the Internet allows users of the client computer systems to exchange information, receive and send e-mails, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 8A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, a network computer, a Web TV system, a handheld device, or other such computer system. Similarly, the ISP 7 provides Internet connectivity for client systems 25, 35, and 37, although as shown in FIG. 8A, the connections are not the same for these three computer systems. Client computer system 25 is coupled through a modem interface 27 while client computer systems 35 and 37 are part of a LAN. While FIG. 8A shows the interfaces 23 and 27 as generically as a “modem,” it will be appreciated that each of these interfaces can be an analog modem, ISDN modem, cable modem, satellite transmission interface, or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31.

FIG. 8B shows one example of a conventional computer system that can be used as a client computer system or a server computer system or as a web server system. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, cable modem, token ring interface, satellite transmission interface, or other interfaces for coupling a computer system to other computer systems. The computer system 51 includes a processing unit 55, which can be a conventional microprocessor such as an Intel Pentium microprocessor or Motorola Power PC microprocessor. Memory 59 is coupled to the processor 55 by a bus 57. Memory 59 can be dynamic random access memory (DRAM) and can also include static RAM (SRAM). The bus 57 couples the processor 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display (LCD). The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images from the digital camera to be input into the computer system 51. The non-volatile storage 65 is often a magnetic hard disk, an optical disk, or another form of storage for large amounts of data. Some of this data is often written, by a direct memory access process, into memory 59 during execution of software in the computer system 51. One of skill in the art will immediately recognize that the terms “computer-readable medium” and “machine-readable medium” include any type of storage device that is accessible by the processor 55 and also encompass a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 59 for execution by the processor 55. A Web TV system, which is known in the art, is also considered to be a computer system according to the present invention, but it may lack some of the features shown in FIG. 8B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 65 and causes the processor 55 to execute the various acts required by the operating system to input and output data and to store data in memory, including storing files on the non-volatile storage 65.

A method and system for managing alert triggers in a relationship system have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

For example, those of ordinary skill within the art will appreciate that although the system has been described in terms of sales prospecting and lead generation, the invention is not so limited and is suitable for use in any environment that utilizes referrals from one person to another. Furthermore, those of ordinary skill within the art will appreciate the term “database” has been used in its generic sense and is intended to encompasses all types of logical data storage, including relational, hierarchical, indexed flat file systems. Therefore, it is manifestly intended that this invention be limited only by the following claims and equivalents thereof.

1. A computerized method comprising:
maintaining a set of alert triggers that define a plurality of operations for detecting changes pertaining to elements of a relationship graph, the elements of the relationship graph including nodes representing entities and edges representing relationships between the entities;
performing the plurality of operations defined by the set of alert triggers; and
providing an alert to one or more users when any of the plurality of operations satisfy an alert condition associated with a corresponding alert trigger from the set of alert triggers.

2. The computerized method of claim 1 wherein providing the alert to the one or more users comprises:
communicating, to the one or more users, information identifying the corresponding alert trigger and a result of said any of the plurality of operations.

3. The computerized method of claim 1 wherein each of the plurality of operations is performed repeatedly based on a frequency associated with a corresponding alert trigger from the set of alert triggers.

4. The computerized method of claim 1 wherein the set of alert triggers comprises a member alert trigger.

5. The computerized method of claim 4 wherein the member alert trigger specifies an operation, an alert condition, an alert trigger frequency, and a user to be alerted when the operation satisfies the alert condition.

6. The computerized method of claim 5 further comprising:
receiving a request for the member alert trigger from the user; and
activating the member alert trigger for the user.

7. The computerized method of claim 6 wherein receiving the request for the member alert trigger comprises:
determining that the user is interested in a result of the operation; and
offering the user to create the alert trigger to be alerted to the result of the operation.

8. The computerized method of claim 5 wherein the member alert trigger is any one of a new search result alert trigger, a new content alert trigger, a weakening relationship alert trigger, a strengthening relationship alert trigger, a newly discovered relationship alert trigger, and a new personal relationship alert trigger.

9. The computerized method of claim 1 wherein the set of alert triggers comprises a global alert trigger.

10. The computerized method of claim 9 wherein the global alert trigger specifies a global operation, an alert condition, and an alert trigger frequency.

11. The computerized method of claim 10 further comprising:
identifying a group of users to be alerted when the global operation satisfies the alert condition.

12. The computerized method of claim 9 further comprising:
receiving a request for the global alert trigger from an administrator; and
activating the global alert trigger.

13. The computerized method of claim 11 further comprising:
determining that a user from the group no longer wants to receive alerts associated with the global alert trigger; and
removing the user from the group.

14. The computerized method of claim 9 wherein the global alert trigger is any one of a weakening relationship alert trigger, a strengthening relationship alert trigger, and a newly discovered relationship alert trigger.

15. A machine-readable medium having executable instructions to cause a machine to perform a method comprising:
maintaining a set of alert triggers that define a plurality of operations for detecting changes pertaining to elements of a relationship graph, the elements of the relationship graph including nodes representing entities and edges representing relationships between the entities;
performing the plurality of operations defined by the set of alert triggers; and
providing an alert to one or more users when any of the plurality of operations satisfy an alert condition associated with a corresponding alert trigger from the set of alert triggers.

16. The machine-readable medium of claim 15 wherein providing the alert to the one or more users comprises:
communicating, to the one or more users, information identifying the corresponding alert trigger and a result of said any of the plurality of operations.

17. The machine-readable medium of claim 15 wherein each of the plurality of operations is performed repeatedly based on a frequency associated with a corresponding alert trigger from the set of alert triggers.

18. The machine-readable medium of claim 15 wherein the set of alert triggers comprises a member alert trigger.

19. The machine-readable medium of claim 18 wherein the member alert trigger specifies an operation, an alert condition, an alert trigger frequency, and a user to be alerted when the operation satisfies the alert condition.

20. The machine-readable medium of claim 19 wherein the method further comprises:
receiving a request for the member alert trigger from the user; and
activating the member alert trigger for the user.

21. The machine-readable medium of claim 20 wherein receiving the request for the member alert trigger comprises:
determining that the user is interested in a result of the operation; and
offering the user to create the alert trigger to be alerted to the result of the operation.

22. The machine-readable medium of claim 18 wherein the member alert trigger is any one of a new search result alert trigger, a new content alert trigger, a weakening relationship alert trigger, a strengthening relationship alert trigger, a newly discovered relationship alert trigger, and a new personal relationship alert trigger.

23. The machine-readable medium of claim 15 wherein the set of alert triggers comprises a global alert trigger.

24. An apparatus comprising:
a trigger database to maintain a set of alert triggers that define a plurality of operations for detecting changes pertaining to elements of a relationship graph, the elements of the relationship graph including nodes representing entities and edges representing relationships between the entities;
a trigger executor to perform the plurality of operations defined by the set of alert triggers; and
a notifier to provide an alert to one or more users when any of the plurality of operations satisfy an alert condition associated with a corresponding alert trigger from the set of alert triggers.

25. The apparatus of claim 24 wherein the notifier is to provide the alert to the one or more users by communicating, to the one or more users, information identifying the corresponding alert trigger and a result of said any of the plurality of operations.

26. The apparatus of claim 24 wherein each of the plurality of operations is performed repeatedly based on a frequency associated with a corresponding alert trigger from the set of alert triggers.

27. The apparatus of claim 24 wherein the set of alert triggers comprises a member alert trigger.

28. The apparatus of claim 27 wherein the member alert trigger specifies an operation, an alert condition, an alert trigger frequency, and a user to be alerted when the operation satisfies the alert condition.

29. The apparatus of claim 27 wherein the member alert trigger is any one of a new search result alert trigger, a new content alert trigger, a weakening relationship alert trigger, a strengthening relationship alert trigger, a newly discovered relationship alert trigger, and a new personal relationship alert trigger.

30. The apparatus of claim 24 wherein the set of alert triggers comprises a global alert trigger.

31. The apparatus of claim 30 wherein the global alert trigger specifies a global operation, an alert condition, and an alert trigger frequency.

32. The apparatus of claim 30 wherein the global alert trigger is any one of a weakening relationship alert trigger, a strengthening relationship alert trigger, and a newly discovered relationship alert trigger.

33. An apparatus comprising:
means for maintaining a set of alert triggers that define a plurality of operations for detecting changes pertaining to elements of a relationship graph, the elements of the relationship graph including nodes representing entities and edges representing relationships between the entities;
means for performing the plurality of operations defined by the set of alert triggers; and
means for providing an alert to one or more users when any of the plurality of operations satisfy an alert condition associated with a corresponding alert trigger from the set of alert triggers.

34. A system comprising:
a processor coupled to a memory through a bus, and further coupled to an I/O interface through the bus; and
a trigger process executed from the memory by the processor to cause the processor to maintain a set of alert triggers that define a plurality of operations for detecting changes pertaining to elements of a relationship graph, the elements of the relationship graph including nodes representing entities and edges representing relationships between the entities, to perform the plurality of operations defined by the set of alert triggers, and to provide an alert to one or more users when any of the plurality of operations satisfy an alert condition associated with a corresponding alert trigger from the set of alert triggers.
